(19) United States
(12) Patent Application Publication
(10) Pub. No.: US 2012/0179935 A1
(43) Pub. Date: Jul. 12, 2012

(54) DYNAMIC TEST GENERATION FOR CONCURRENT PROGRAMS

(75) Inventors: Chao WANG, PLAINSBORO, NJ (US); Mahmoud SAID, PLAINSBORO, NJ (US); Aarti GUPTA, PRINCETON, NJ (US); Vineet KAHLON, PRINCETON, NJ (US); Nishant SINHA, PLAINSBORO, NJ (US)

(73) Assignee: NEC LABORATORIES AMERICA, INC., Princeton, NJ (US)

(21) Appl. No.: 13/348,286

(22) Filed: Jan. 11, 2012

Related U.S. Application Data
(60) Provisional application No. 61/431,658, filed on Jan. 11, 2011.

(51) Int. Cl. G06F 11/36

(52) U.S. Cl. 714/32; 714/E11.208

(57) ABSTRACT

A computer implemented method for dynamic test generation for concurrent programs, which uses a combination of concrete and symbolic execution of the program to systematically cover all the intra-thread program branches and inter-thread interleavings of shared accesses. In addition, a coverage summary based pruning technique, which is a general framework for soundly removing both redundant paths and redundant interleavings and is capable of speeding up dynamic testing exponentially. This pruning framework also allows flexible trade-offs between pruning power and computational overhead to be exploited using various approximations.

### CROSS REFERENCE TO RELATED APPLICATION

This application claims the benefit of U.S. Provisional Patent Application Ser. No. 61/431,658 filed Jan. 11, 2011 which is incorporated by reference in its entirety as if set forth at length herein.

### TECHNICAL FIELD

This disclosure relates generally to the field of computer software and in particular to a method for the dynamic test generation of concurrent software programs.

### BACKGROUND

Concurrent software programs are notoriously difficult to verify because each individual thread of the concurrent software program may have a large number of sequential paths and the entire concurrent software program may have a large number of interleavings of global accesses embedded into these sequential paths.

Accordingly, methods which permit the more effective verification of concurrent software programs and systems employing same would represent a welcome addition to the art.

### SUMMARY

An advance in the art is made according to an aspect of the present disclosure directed to a computer implemented method for testing concurrent software programs. In sharp contrast to prior art methods which operated on either sequential software programs or concurrent software programs that already have a data input, the method according to the present disclosure employs a unified dynamic test input generation verification that is efficient; works for concurrent software programs; and generates tests that cover both program paths and thread interleavings. According to an aspect of the present disclosure, efficiency is enhanced through the use of a coverage summary based pruning method which can record—during dynamic testing—any already tested branches of the software program that are reachable from a certain global control state. As a result, a testing method according to the present disclosure will avoid repeating the same execution traces thereby providing faster operation and lower cost for finding concurrency bugs while simultaneously improving test coverage.

As will be appreciated by those skilled in the art, since concurrent software program behavior (which sequential paths are executed and in what order) is determined by a combination of the data input (DI) and the thread schedule (TS), testing needs to search in both the DI and TS spaces, to achieve a reasonable coverage of both the sequential paths and their interleavings. Advantageously, methods according to the present disclosure achieve these ends.

### BRIEF DESCRIPTION OF THE DRAWING

A more complete understanding of the present disclosure may be realized by reference to the accompanying drawings in which:

FIG. 1 shows two example concurrent programs and their generalized execution graph (GIG) according to an aspect of the present disclosure;

FIG. 2 shows two examples illustrating deadlock and abort detection;

FIG. 3 shows a schematic illustrating the coverage summary based pruning for program (1) in FIG. 1 according to an aspect of the present disclosure;

FIG. 4 is a schematic illustrating an example for computing the coverage summaries and for evaluating them for search space pruning according to an aspect of the present disclosure;

FIG. 5 shows a schematic illustrating the coverage summary based pruning for program (2) in FIG. 1 according to an aspect of the present disclosure;

FIG. 6(a) shows a graph illustrating the experimental results on qsort_mt examples: the y-axis is the run time in seconds for 2 threads and array size of 4, 6, 8, 10 . . . , according to an aspect of the present disclosure;

FIG. 6(b) shows a graph illustrating the experimental results on qsort_mt examples: the y-axis is the run time in seconds for m=2 threads and array size of 2 m, according to an aspect of the present disclosure;

FIG. 7 shows a listing of Algorithm 1 depicting dynamic test generation for concurrent programs according to an aspect of the present disclosure;

FIG. 8 shows a listing of Algorithm 2 depicting dynamic test generation for concurrent programs according to an aspect of the present disclosure;

FIG. 9 shows conceptual schematic diagram of coverage summary approximation according to an aspect of the present disclosure;

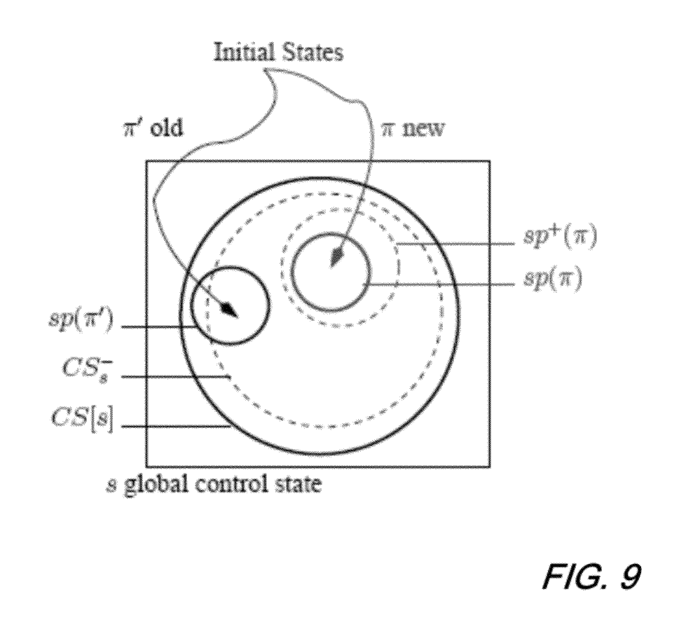

FIG. 10 shows Table 1 which compares the testing performance both with and without pruning according to an aspect of the present disclosure;

FIG. 11 shows a schematic block diagram of a general purpose computer system executing a method according to an aspect of the present disclosure;

FIG. 12 shows a flow diagram depicting the method according to an aspect of the present disclosure;

FIG. 13 shows a flow diagram depicting the details of block 16—Dynamic Test Input Generation—of the flow diagram of FIG. 12, according to an aspect of the present disclosure; and

FIG. 14 shows a flow diagram depicting the details of block 18—Coverage Summary Based Pruning—of the flow diagram of FIG. 12, according to an aspect of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

Introduction

Concurrent programs are notoriously difficult to verify due to two reasons: each individual thread may have a large number of sequential paths, and the whole program may have a large number of interleavings of global accesses embedded in these sequential paths. The failures in a concurrent program can be classified into two categories: some are the same as failures in a sequential program, e.g. failed assertions, while others are specific to concurrency, e.g. deadlocks and data races. However, regardless of the types of these failures, they typically occur only in some certain interleaved executions of certain thread sequential paths. Since the program behavior (which sequential paths are executed and in what order) is determined by a combination of the data input (DI) and the thread schedule (TS), testing needs to search in both the DI and TS spaces, to achieve a reasonable coverage of both the sequential paths and their interleavings.

For concurrent programs with fixed data input, there exist CHESS-like systematic testing tools for executing the program under all possible (optionally, with bounded context switching) thread schedules with respect to that data input. If these executions expose some concurrency related bugs such as deadlocks and data races, they will be reported together with logged thread schedules for deterministic replay. Although code coverage (as measured for instance by statements or branches or paths) can be easily assessed during execution, in these tools there does not exist a feedback process through which new data inputs are automatically computed to increase code coverage. A prior work that came close to achieving this goal is ESD, which uses a combination of static and symbolic execution to construct a concurrent execution that is consistent with a given crash report (e.g. the core-dump file). However, this method is geared toward heuristically synthesizing a bug-bound path for the given crash, rather than systematically testing the program to cover all possible program behaviors.

For sequential programs, there has been exciting development recently on dynamic test generation using symbolic execution. These techniques are based on executing the program concretely as well as symbolically, and generating new data inputs by solving symbolic constraints that force some branches along the current execution to be flipped. The use of concrete execution is key to both limiting the overhead and increasing the precision of symbolic execution, a powerful static analysis that otherwise will be either too expensive or too imprecise (when over-approximated). Although the effectiveness of this approach has been demonstrated by many recent tools, they all aim at testing sequential programs only, not concurrent programs.

One main difficulty in concurrent program testing is that threads are not composable, meaning that it is difficult to test sequential threads in isolation and then, based on the correctness of these threads, to establish the correctness of the entire program. Therefore, a straightforward combination of first applying a DART-like sequential testing tool to each sequential function and then applying a CHESS-like concurrency testing tool (with fixed data input) to the whole program does not work. When sequential functions are tested in isolation, some valid paths (valid during whole program execution) may become infeasible without the cooperation from other threads, and some invalid paths may become feasible since constraints from cooperating threads are missing. This can lead to both bogus errors and missed errors, therefore also losing a useful no-bogus-error feature of dynamic testing. This can also make function summary based compositional testing techniques difficult to apply.

As will be appreciated by those skilled in the art, we present a general framework for dynamic and symbolic testing of concurrent programs.

More specifically, we consider a concurrent program P with some input program variables explicitly specified e.g. char x=havoc( ). We use a combination of concrete and symbolic executions to generate new tests of the form (I, sch) where I is the data input and sch is the thread schedule, in order to effectively cover all valid sequential paths as well as all possible interleavings of global accesses within these sequential paths. As is typical in testing, we focus on the decidable subset of the verification problem by assuming that the program is terminating or can be made so using a test harness. We also assume that all detectable sequential failures are modeled as abort statements whose reachability indicates the existence of failures. This means, for example, modeling assert(c) as if(!c)abort, modeling x=y/z as if(z==0)abort;else x=y/z, and modeling t→k=5 as if(t==0)abort;else t→k=5 . Therefore, we consider only two types of bugs: aborts in the sequential flow and deadlocks in the interleavings. It is worth pointing out that we focus on these actual program failures only, not anomalies such as data races which may not lead to failures (e.g. data races may be benign). However, our focus on these bugs does not make the testing problem less general or challenging. Consider that aborts may appear anywhere in a sequential path, and deadlocks may happen in any global program state, testing may need to effectively cover all the valid thread paths and interleavings of their global accesses. Our unified dynamic testing framework can accomplish both coverage goals systematically.

As the second contribution of this paper, we present a redundancy removal technique within the new dynamic testing framework, called Coverage Summaries (CS) based pruning The main insight is that for detecting all aborts/deadlocks, very often we do not need to test all the possible interleavings of all sequential paths. We introduce the notion of coverage summary, denoted CS[n] for global control state n (a tuple of the thread program counters), which captures the set of already covered executions starting with n (the execution suffixes). When n is visited again, presumably in another execution π, if the symbolic execution of π up to state n implies the validity of CS[n], then we can safely skip all the suffixes starting with n. The pruning of these suffixes is a sound reduction of program executions since it does not affect the detection of aborts/deadlocks. Furthermore, since there can be exponentially many more interleavings than global control states (much like in sequential programs, where there can be exponentially many more paths than control locations), this coverage summary based pruning may speed up dynamic testing exponentially.

The coverage summary at a global control state n is different from the set of forward or backward reachable states at n in classic software model checkers or stateful-DPOR algorithms for concurrency testing. These prior efforts store the forward reachable program states explicitly in some data structure to prevent them from being explored again. In contrast, CS[n] is a formula effectively capturing all the previously tested branches and interleaving points, not states or paths. When CS[n]=true, for example, it means that no execution starting with n can lead to a not-yet-tested branch or global control state; it does not mean that all the reachable program states at n have been covered. This also explains the key difference between coverage summaries and McMillan's lazy annotations, which are essentially over-approximated versions of the forward reachable state sets constructed using interpolants. This lazy annotation method has been defined only for sequential programs in a DART-like testing framework, and it has not been applied to concurrent programs.

Generalized Interleaving Graph (GIG)

In this section, we define concurrent programs, their concrete and symbolic execution traces, and the generalized interleaving graph.

A concurrent program P has a set SV of shared variables and a set of threads T₁ . . . Tₘ. Each thread Tᵢ, where 1≦i≦m, is a sequential program with a set LVᵢ of thread-local variables and a set of program statements. An execution instance of statement st is called an event, denoted e= [symbol] tid,l,st,l′ [symbol] where tid ∈{1 , . . . , m} is the thread index and l,l′ are the thread-local locations before and after st. When the same program statement st appears in more than one event, the locations are duplicated in order to make l,l ′ unique to each event (corresponding to an unrolled control flow graph). The statement st in event [symbol] i,l,st,l′ [symbol] may have one of the following types. Here we use vₗ to denote a local variable, v_{g} to denote a shared variable, expₗ to denote a local expression—one that depends solely on local variables, and exp_{g} to denote a global expression—one that depends on some shared variables.

halt, representing normal program termination;

abort, representing faulty program termination (assertion failure);

α-operation, which is a local assignment vₗ:=expₗ;

β-operation, which is a local if (expₗ) statement;

γ-operation on threads (I) or shared variables (II) or synchronizations (III):
γ-I, either fork (j) which starts thread Tⱼ, or join (j) which joins Tⱼ back;
γ-II, either shared variable write v_{g}:=expₗ or read vₗ :=exp_{g};
γ-III, a synchronization modeled by the atomic assume(exp_{g}){v_{g}:=exp′_{g}}.

If a γ-II operation is v_{g}=exp_{g}, we rewrite it to vₗ:=exp_{g} and v_{g}:=vₗ. Similarly, we rewrite if(exp_{g}) into vₗ:=exp_{g} and if(vₗ). For γ-III operations, we consider two types of primitives: locks and condition variables, which are the foundation of both PThreads and Java threads. These γ-III operations are modeled as follows:

lock (lk) as assume(lk=⊥) {lk:=i} where i is the owner thread index, and ⊥ means the lock is free;

unlock (lk) as assume (lk=i) {lk:=⊥};

notify (cv) as assume(true) {cv:=1} where non-zero value means cv is notified;

notifyall (cv) as assume (true) {cv:=MT} where inf means positive infinity;

wait (cv, lk) is modeled by two consecutive but non-atomic operations:
wait₁(cv,lk), as assume (lk=i){cv:=0,lk:=⊥;
wait ₂(cv,lk), as assume (cv≠0 [symbol] lk=⊥) {cv:32 cv−1,lk:32 i.

According to the POSIX standard, the thread calling wait (cv, lk) releases the associated lock (modeled by wait₁) and then blocks, waiting for another thread to call notify (cv) or notifyall (cv). After that, it re-acquires the lock (modeled by wait ₂) before waking up the caller thread.

A program execution can be represented by a concrete data input (I) and a sequence π=eₗ . . . eₙ of events. The thread schedule (sch) is the total order of events in π; in the actual implementation, sch=eₗtid . . . eₙ.tid provides the thread eᵢ.tid at the i-th interleaved execution step. The pair (I, π) or equivalently (I,sch) is called a test, uniquely representing a concrete execution. With symbolic data, the pair (*, π) or simply π represents a symbolic execution (set of concrete executions).

A global control state is a tuple s= [symbol] lₗ, . . . , lₘ [symbol] where cach lᵢ (1≦i≦m) is a location in thread Tᵢ. Therefore, a global control state s is an abstract state, different from a concrete program state at s, which includes also the concrete values of all the program variables. For m threads, each with k locations, there are at most k^{m} global control states, with possibly infinite concrete states (e.g. unbounded data).

Assuming that the program is terminating and all detectable failure are either aborts or deadlocks, we anticipate three possible testing outcomes: (1) abort found, (2) deadlock found, or (3) no failure possible. When π is deadlock-free, it is a finite word in {α|β|γ}*{halt|abort}: we regard π as a good execution if it ends with halt, and a faulty execution if it ends with abort. We say that π has a deadlock if it ends with a program state in which all active threads are disabled. For programs using PThreads (or Java threads), a thread may be disabled due to three reasons: (i) executing lock(lk) when lk is held by another thread; (ii) executing wait ₂ (cv) when cv is 0; (iii) executing join(j) when thread Tⱼ has not terminated. For simplicity, we do not focus on anomalies such as data races which may not lead to failures (e.g. data races may be benign).

Conceptually, dynamic testing is illustrated by Algorithm 2. Procedure runTest executes the test concretely, detects failures, and returns trace π—as a sequence of symbolic events. The tested traces are recorded in covered and are used by genNewTest, which tries to find a new test (I, sch) while avoiding the tested traces from being generated again. When this algorithm terminates (before running out of the allocated time/memory resources), covered contains all the possible execution traces of the program. Therefore, upon termination, testing becomes verification since it has explored all valid program executions relevant to detecting failures.

In the conventional algorithms, i.e. without the pruning of redundant test executions, genNewTest may be implemented as follows:
Let (I,sch) be a new test that leads to a run ρ∉covered;

In our proposed algorithm, the set covered is generalized to cover a larger set of test executions (called the coverage summary CS), and CS is then used to prune away more redundant test runs (than those in covered). Therefore, genNewTest may be implemented as follows:
Let CS be an abstract interpretation of the set covered;
Let (I,sch) be a new test that leads to a run ρ∉CS ;

The definition of CS will be given later.

Generalized Interleaving Graph (GIG). The set of all possible executions of a concurrent program can be represented succinctly as a generalized interleaving graph, where nodes are global control states and edges are events. The root node corresponds to the initial global control state and the terminal nodes correspond to the end of executions. The outgoing edges at each node n corresponds to the events that can be executed at n. Each non-terminal node may have one outgoing edge (local assignment as α-event), two outgoing edges (local branches as β-events), or k (where 1≦k≦m) outgoing edges (global accesses as γ-events). Each root-to-terminal path in the GIG corresponds to a symbolic execution of the program.

We call a GIG node n with more than one outgoing edge a Pivot Point (PP). A pivot point is further classified as either an interleaving Pivot Point (i-PP), whose outgoing edges are γ-events, or a branching Pivot Point (b-PP) whose outgoing edges are β-events. Although during execution, context switches between threads may happen at any point of time, during program analysis, we can safely restrict context switches between threads to happen at i-PP nodes only, because local events at b-PP or non-PP nodes are invisible to other threads, and therefore their interleavings can be avoided based on partial order reduction.

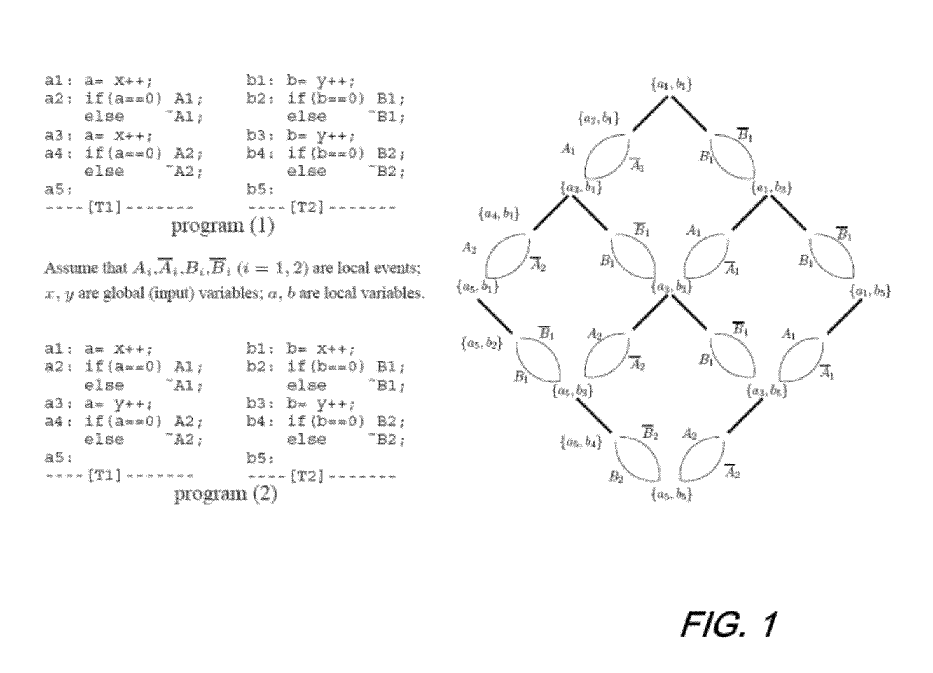

FIG. 1 (right) provides an example GIG, which corresponds to program (1) on the left. This program has two concurrent but totally independent threads, and therefore the test data input (initial values of x, y) fully determines which thread-local branch to take. For simplicity we assume that a=x++ is atomic¹. The root node of the GIG corresponds to global control state (a₁,b₁), whereas the terminal node corresponds to (a₅,b₅). Nodes such as (a₁,b ₁) are i-PP nodes: from (a₁,b₁) we may execute thread 1 leading to (a₂,b₁) and then (a₃,b₁), or thread 2 leading to (a₁,b₂) and then (a₁,b₃). Nodes such as (a₂,b ₁) are b-PP nodes: from (a₂,b ₁) we may take if (a=0) leading to Aₗ or if (a≠0) leading to Ā₁. ¹Imagine it being lock(lx);ax++;unlock(lx) with lock lx guarding all accesses to x.

The GIG is a generalization of the unrolled control flow graph for sequential programs. In fact, for sequential programs, the GIG automatically degenerates into an unrolled CFG with b-PP and non-PP nodes only. Many of the DART-like testing tools effectively operate on such graphs to cover all valid sequential paths. At the same time, the GIG is a generalization of the interleaving lattice for concurrent threads with straight-line code. In this case, the GIG degenerates into a graph with i-PP and non-PP nodes only. The classic theory of partial order reduction based on trace-equivalence effectively operates on such a lattice with the goal of covering all the possible, but irredundant, interleavings.

Although full-fledged verification requires effectively² exploring all the possible interleaved program executions, for detecting aborts/deadlocks, the testing process can often be stopped earlier, e.g. when testing already covers (1) all the i-PP nodes and (2) all the b-PP branches. Indeed, if all the b-PP branches are covered and we have not encountered any abort statement, then we have a proof that the program does not have abort failure. Similarly, if all the i-PP nodes are effectively covered and we have not encountered any deadlock, then we have a proof that the program does not have deadlock. Now we illustrate why, short of covering all the reachable i-PP nodes and b-PP branches, one cannot guarantee the detection of all aborts/deadlocks. ²With partial order reduction it is possible to safely skip some of these interleavings.

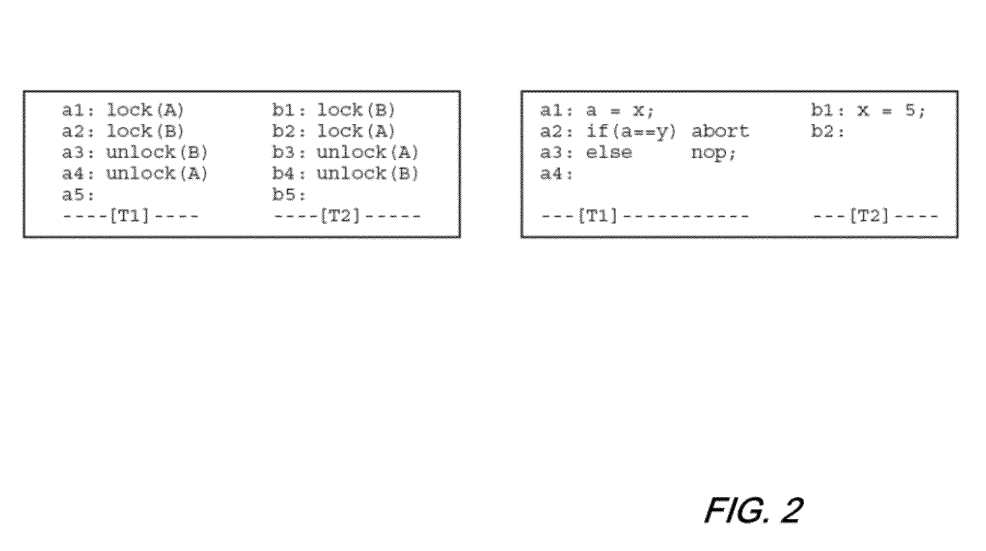

In FIG. 2 (left), although the (serial) execution a₁a₂a₃a₄b₁b₂b₃b₄ covers all statements and branches (there is none), if we stop testing at this point, the deadlock in execution aᵢbᵢ will be missed. Similarly, FIG. 2 (right) shows that covering all the i-PP nodes alone does not guarantee the detection of all aborts. In this example, x is shared and the branch condition at a₂, a₃ depends on both x and y. Assume that the data input is x=0,y=1. Although executions aᵢa₃bᵢ and b₁a₁a₃ together cover all the i-PP nodes, if we stop testing at this point, we will miss the abort hidden in a₂.

In the worst case, in order to generate enough tests that can (i) cover all the reachable i-PP nodes and b-PP branches, the testing algorithm will end up (ii) exploring all the interleaved program executions. The reason is that, for any given i-PP node (or b-PP branch), deciding whether it is reachable (via an interleaved execution) is fundamentally difficult—it requires exhaustive search. However, there should be a clear distinction between the goal (i) and the means (ii) to achieve it. Consider, for example, a simple case where all i-PP nodes and b-PP branches are reachable, and are covered at some point of time during testing; in this case we can safely stop the testing process early, even if many interleaved executions have not been explored. This is the main insight behind our coverage summary based pruning technique.

Flipping at the Pivot Points

We first explain the key dynamic testing subroutines by referring to the high-level Algorithm 1, and then present the detailed pseudo code of our framework in Algorithm 2.

Generating New Execution Traces. Subroutine genNewTest in Algorithm 2 is responsible for generating a new test of the form (I′,sch′) based on the already tested traces in covered, and more importantly, the current execution trace π=e₁ . . . eₙ. Assume that π is generated by test (I,sch), and s₁ . . . sₙ₊₁ are global control states visited by π, such that

$${s}_{1} {->}^{{e}_{1}} … {s}_{n} {->}^{{e}_{n}} {s}_{n + 1} .$$

Let sₖ, where 1≦k≦n, be a pivot point (either i-PP or b-PP). Then we say that (I′,sch′) is a new test if it can force the execution to follow the same prefix eₗ . . . eₖ₋₁ up to this pivot point sₖ but then execute an event other than eₖ. Such new tests can be computed as follows:

if sₖ is an i-PP node, and e′≠e is another enabled γ-event at sₖ, let I′=I and sch′=e₁.tid . . . eₖ₋₁.tid (e′.tid).

if sₖ is a b-PP node with

$${s}_{k} {}^{if ( c )} {s}_{k + 1} ,$$

and e′ is if( [symbol] c), we create a first-order logic formula Φ:=sp(e₁ . . . eₖ₋₁, true) [symbol] [symbol] c, where sp is the standard strongest postcondition of true (symbolic data input) over π. If Φ is proved to be satisfiable using an SMT solver, we can derive I′ from its solution and let sch′=e₁.tid . . . eₖ.tid. (Note that eₖ.tid=e′.tid.)

When the new test (I′,sch′) is applied, we supervise the first k steps of the program execution, ensuring that it follows sch′ precisely; however, after the flipping at sₖ, the remaining part of this execution is a free run.

When π has multiple pivot points, it is possible to generate different new tests based on where to flip first, therefore affecting the order in which the GIG paths are explored during testing. Consider, for instance, the strategy of always flipping at the last pivot point of π; it would lead to a Depth-First Search (DFS) of the GIG paths. Other strategies include Breadth-First Search (BFS) and Generational Search (GS).

In general, it is possible to have a symbolic procedure decide the next pivot point based on a symbolic encoding of the GIG.

Recording Tested Execution Traces. The set covered in Algorithm 2 records the already tested traces in order to avoid repeating them. Since the number of traces can grow exponentially large, a naive implementation of the set covered can become a bottleneck. This is the reason why we choose the DFS strategy: it leads to a linear storage overhead for covered: only the current trace π with some additional annotations at each global control state along π. We use a small example to illustrate why this is possible. Consider

$${π}_{1} = {->}^{{a}_{1}} {s}_{1} {}^{{p}_{1} {a}_{2}} {s}_{2} {}^{{p}_{2} {a}_{3}} {s}_{3} {}^{{p}_{3} {a}_{4}} {s}_{4} {->}^{{p}_{4}}$$

where aᵢ is an α-event and pᵢ is β- or γ-event for i=1,2,3,4. Also assume that each pivot point (sᵢ) has two choice events pᵢ, p̅ᵢ. Following DFS, we can list the sequence of tested traces as follows, together with the covered set at each step (symbol ‘*’ means both pᵢ and p̅ᵢ are covered):
π₁=a₁ p₁a₂ p₂a₃ p₃a₄ p₄ covered={a₁ p₁a₂ p₂a₃ p₃a₄ p₄}
π₂=a₁ p₁a₂ p₂a₃ p₃a₄ p̅₄ covered={a₁ p₁a₂ p₂a₃ p₃a₄*}
π₃=a₁ p₁a₂ p₂a₃ p̅₃̅a₄ p̅₄̅ covered={a₁ p₁a₂ p₂a₃*a₄ p₄}
π₄=a₁ p₁a₂ p̅₂̅a₃ p₃a₄ p₄ covered={a₁ p₁a₂ p₂a₃*a₄*}
π₅=a₁ p₁a₂ p₂a₃ p₃a₄ p₄ covered={a₁ p₁a₂*a₃ p₃a₄ p₄}

In other words, although covered may contain exponentially many elements, the size of its representation does not grow. In practice, we implement the set covered as a stack S=s₁ . . . sₙ₊₁ of abstract states, where each sᵢ∈S is a global control state such that

$${s}_{1} {->}^{{e}_{1}} … {s}_{n} {->}^{{e}_{n}} {s}_{n + 1} .$$

Furthermore, each sᵢ∈S has the following fields:

sᵢ.branch denotes the set of both eᵢ: if(c) and ēᵢ: if( [symbol] )when sᵢ is a b-PP node;

sᵢ.branched, consisting of the branches covered by at least one tested trace;

sᵢ.enabled denotes the set of enabled events when sᵢ is an i-PP node;

sᵢ.explored, consisting of enabled events covered by at least one tested trace.

It is important to note that the fields of sᵢ are associated with the current trace π in stack S, not with the global control state sᵢ itself. Consider the above example, when we generate π₃ from π₂, state s₄ in π₂ is popped out of S and then is recreated with fresh s₄.branched and s₄.explored

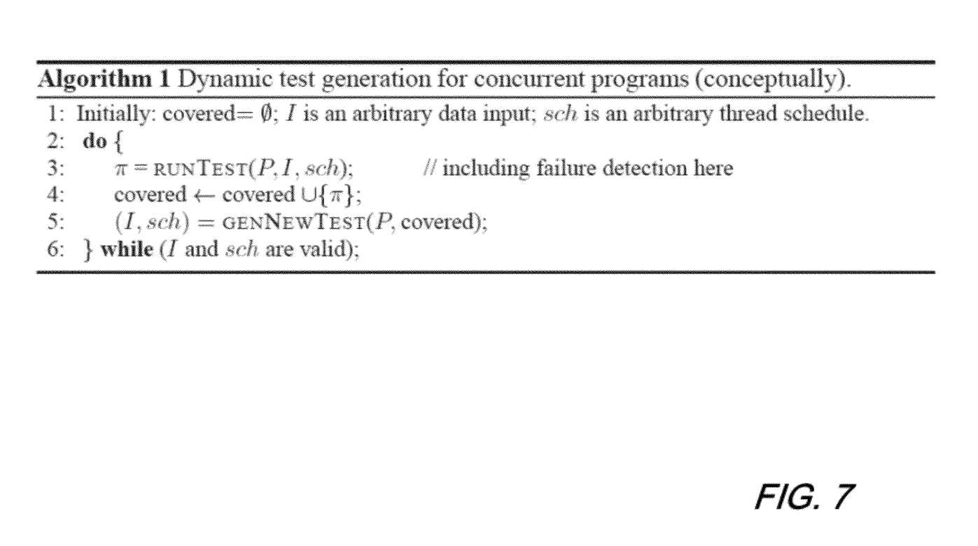

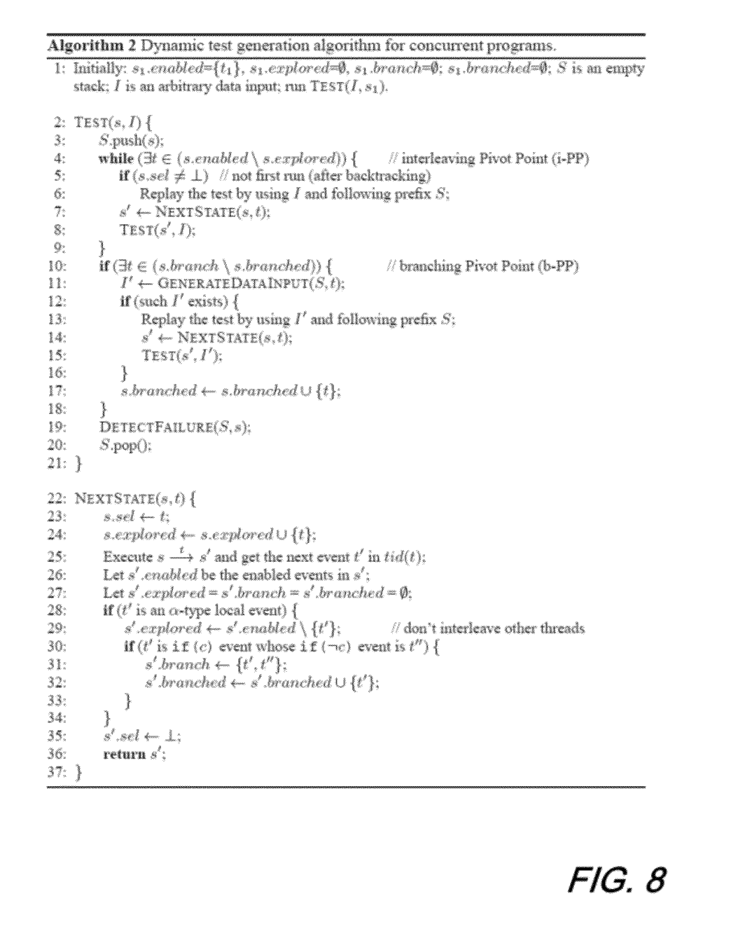

The Detailed Overall Algorithm. The pseudo code of our dynamic testing framework is presented in Algorithm 2 (FIG. 8), which can be viewed as a particular way of refining Algorithm 1 (FIG. 7). Recursion is shown solely for ease of presentation; we use loops during implementation. It starts with Test(s₁, I) using the initial state s₁ (with the enabled event t₁) and an arbitrary (I,sch). At each step, it records the current global control state s into stack S, picks an event t, and then calls NextState (s, t). Inside this procedure, it sets the fields of s : the executed event (s.sel), explored interleaving events (s.explored), and explored branches (s.branched). The while-loop at lines 4-9 is executed only once if s is a b-PP or non-PP node; it may be executed more than once when s is an i-PP node (once for each enabled γ-event). The if-block at lines 10-18 is not executed if s is a non-PP or i-PP node, and is executed only if s is a b-PP node (for its second β-event). Before reaching this point, the first β-event at the b-PP node s has already been executed (within lines 4-9).

A test run terminates when s.enabled becomes empty, leading to s.sel=⊥ at the backtracking point (line 20). Then we call the procedure at line 19 to detect failures: whenever s.sel=⊥, we check s′.sel, the executed event at the previous state s′:

if s′.sel=halt, this run ends normally;

if s′.sel=abort, this run ends with a failure;

if s′.sel≠abort/halt, this run ends with a deadlock.

If this test run ends normally, Test (s, I) backtracks all the way to the previous pivot point, which may end up in either line 8 or line 15, and starts another test run from there. Since reversely executing a program is difficult, here backtracking is implemented by starting the program afresh and supervising it to follow the new (I′, sch′). During this deterministic replay process, it is important to make sure that all external behaviors (e.g., mallocs and IO) are stubbed properly and as a result, nondeterminism during the program execution can come only from (I′, sch′). By repeating this iterative process, eventually we will backtrack from the initial call Test (s₁, I). At this point, we have forced the exploration of all valid interleaved executions of the program as characterized by the distinct root-to-terminal paths in the GIG.

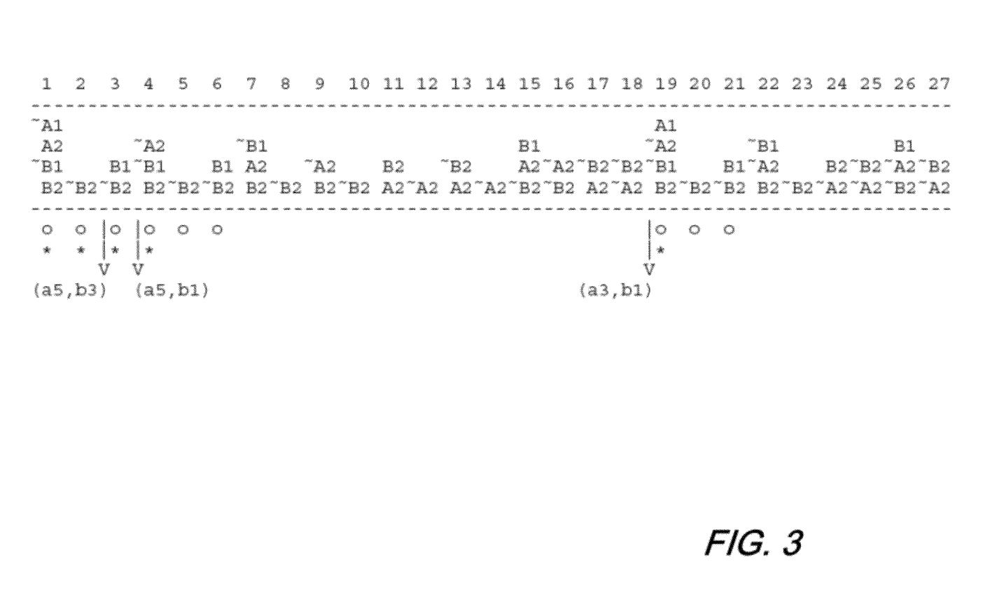

Standard partial order reduction (POR) techniques can be used at i-PP nodes to remove redundant interleavings. In our implementation we have used the DPOR algorithm as in although other techniques may also be used. Consider program (1) in FIG. 1, which has a total of 54 valid runs (for brevity, only the first 27 runs are listed in FIG. 3). Run 1, denoted by the branches taken, Ā₁, A₂, B̅₁, B₂, corresponds to the test where the data input is x=−1, y=−1 and the thread schedule is sch=T₁ . . . T₁T₂ . . . T₂ ; it is one of the left-most GIG paths in FIG. 1. From run 1, our algorithm can systematically generate all the 54 valid executions. Since the two threads do not interfere, using partial order reduction we can reduce the 54 runs to the 9 runs marked by symbol ‘∘’ in FIG. 3.

However, we stress that the focus of this paper is not on partial order reduction. In the next section, we present a novel, and orthogonal, redundancy removal technique called coverage summary based pruning This technique can be used together with POR, and is capable of speeding up dynamic test generation exponentially.

Pruning with Coverage Summaries

We are motivated by the fact that the number of valid GIG paths can be exponential in the number of GIG nodes, many GIG paths can be regarded as redundant for detecting failures and therefore skipped. Before going into the details, we revisit the 54 valid runs of our example in FIG. 3. Even after POR, some of the 9 remaining runs marked by ‘∘’ are still redundant. In fact, only the 5 runs marked by ‘*’ are needed in order to cover all the b-PP branches and i-PP nodes. Therefore, an ideal testing algorithm should test only runs 1-4, 19 and then terminate, knowing that the remaining runs are redundant. The question is how to identify and remove these redundant runs? To this end we introduce the notion of coverage summary.

Computing the Coverage Summaries

We provide the intuition behind coverage summaries using the test runs in FIG. 3. Here runs 1 and 2 share the same execution prefix up to global control state (a₅,b₄) and then take different b-PP branches; together, these two runs cover all the possible b-PP branches (B₂ and B̅₂) that can ever be reached from (a₅,b₄) by any test run. Therefore, whenever we reach the b-PP node (a₅,b₄) again, e.g. in test run 4, although we should have flipped at this b-PP again, knowing that we will never reach any new b-PP branch by continuing the execution from (a₅,b₄), we backtrack immediately without flipping at this b-PP node, hence skipping test run 5.

More formally, given a set covered of tested runs, for each global control state s, we define a coverage summary CS[s] as a formula capturing the already tested b-PP branches and i-PP choices that may be reachable from s. CS[s] has one of the following forms:
true when s is a covered terminal global control state
false when s is a not—yet—covered terminal state
substitute(CS[s′], v, expr) when s′ is the successor state of assignment v:=expr
ite(c,CS[s′],CS[s″]) when s′,s″ are the two successor states of if (c) . . . else
ipp(CS[s′], . . . , CS[s^{k} ]) when s¹, . . . , s^{k} are the successor states of an i-PP node

We compute the coverage summaries for all global control state s incrementally.

Initially CS[s]:=false for every terminal state s (and hence for all states).

Whenever a program statement at state s is covered by a new test run, update CS[s] based on the above rules.

Since CS[s] is defined across multiple runs, it needs to be stored on a persistent map (requiring extra memory) rather than inside the state s∈S of each execution trace, whose fields are destroyed every time we backtrack from s.

Whenever we try to flip a branch or thread at state s of the current execution trace, we check whether the new test (to be generated) is redundant. This is accomplished by first computing the set of reachable states at s, and then deciding whether they are covered by the previous tests. The set of already covered execution traces (starting at s) can be computed by evaluating CS[s]. The recursive evaluation of CS[s], denoted eval(CS[s]), is defined as follows:

eval(substitute(CS[s′],v,expr)):=eval(CS[s′])(exp/v)

eval(ite(c, CS[s′], CS[s″])):=c [symbol] eval(CS[s′]) [symbol] [symbol] c [symbol] eval(CS[s″])

eval(ipp(CS[s¹], . . . , CS[s^{k}1)):=eval(CS[s¹]) [symbol] . . . [symbol] eval(CS[s^{k} ])

Let φ(v) be a formula and 0(w/v) be the substitution of variable v with formula w. For more information about the pruning, please refer to Section 4.2.

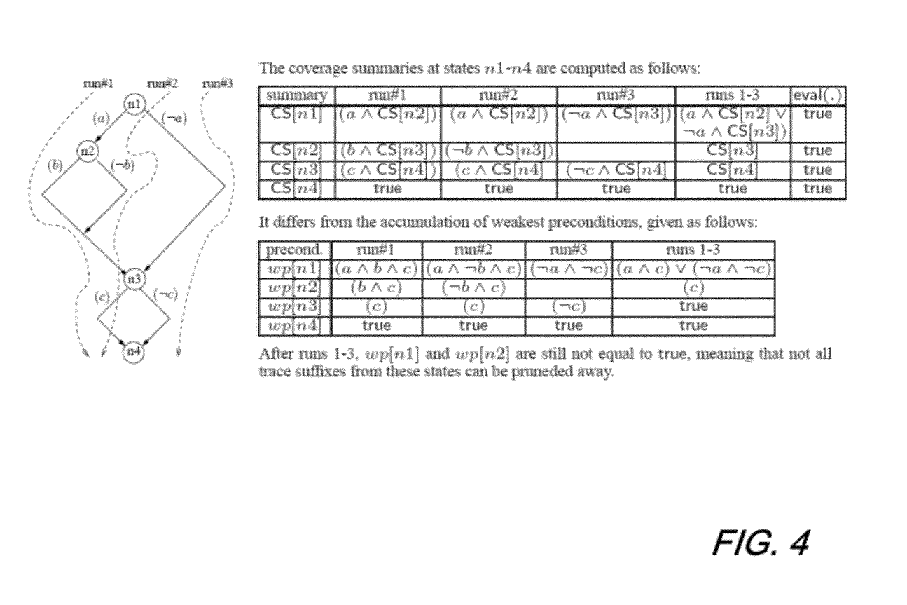

We illustrate in FIG. 4 the difference between coverage summary CS[s] and the union of standard weakest preconditions in state s, denoted wlp[s]. In this example, we assume that the test runs for the program at the left-hand side is in the order: run#1, run#2, and run#3. With the proposed coverage summary CS[s], after the above three test runs, we can prune away all the future execution suffixes starting at n1, n2, n3 and n4. This is in contrast to the naive accumulation of weakest precondition wp[s]: after the above three test runs, one still cannot prune away all the execution suffixes starting at states n1 and n2.

### EXAMPLE 1

Consider the motivating example in FIG. 3, which is a complete C program with two threads. Assume that x=−1, y=−1 is the initial data input and T₁ . . . T₁T₂ . . . T₂ is the thread schedule. This leads to test run 1 which executes b-PP branches Ā₁, A₂, B̅₁, and B₂. We compute CS[(a₅,b₅)]=true and flip at the last b-PP node (a₅,b₄) in order to create a new test. When we backtrack, we set CS[ (a₅,b₄)]=(α≠0).

Assume that x=−1, y=−2 is the new data input leading to test run 2. When we backtrack, we update CS[(a₅,b₄)]:=CS[(a₅,bₐ) [symbol] (α=0). We compute CS[(a₅,bₐ)]=CS[(a₅,b₃)]=true and flip at b-PP (a₅,b₂) to create another test.

Assume that x=−1, y=0 is the new data input leading to test run 3. We compute CS[(a₅,b₁)]=true and flip at b-PP (a₄,b₁) to create another test.

Assume that x=−2, y=−1 is the new data input leading to test run 4. We avoid flipping at the two b-PP nodes due to CS[(a₅,b₂)] and CS[(a₅,b₄)], and avoid flipping at i-PP (a₃, b₁) due to POR. We set CS[(a₃,b₁k)]=true and flip at b-PP (a₂,b₁).

Assume that x=0, y=−1 is the new data input leading to run 19. All the b-PP branches and i-PP nodes are effectively covered. Therefore, our testing process terminates.

We note that CS[s]=true is only a special case. Even if CS[s] is not a tautology, it may still be used for pruning redundant execution suffixes starting with s. In the general case, CS[s] represents a set of concrete program states at s from which all the reachable branches and interleaving points are already covered. If by following another execution π, we reach the global control state s again, we need to check whether all the concrete program states reached via π are included in CS[s]. If this is the case, then we can still use CS[s] to prune away execution suffixes starting with s.

The formula CS[s] is different from the set of forward or backward reachable states in classic software model checkers or stateful-DPOR algorithms. CS[s] is significantly more abstract since it captures a set of executed branches and interleaving points, not states or paths. In contrast, the set of forward (or backward) reachable states at s can be thought of as equivalent to the union of all strongest postconditions (or weakest preconditions) accumulated over some executions leading to s. This also explains the key difference between CS[s] and McMillan's lazy annotations (only for sequential programs, not for concurrent programs), which are essentially over-approximated sets of forward reachable state constructed using interpolants.

Using the Coverage Summaries

Now we explain how to decide, when global control location sᵢ is reached again through prefix π=e₁ . . . eᵢ₋₁, whether we can backtrack immediately without exploring suffixes starting with sᵢ. Given the current execution

$${s}_{1} {->}^{{e}_{1}} … {s}_{i - 1} {->}^{{e}_{i - 1}} {s}_{i} ,$$

we compute the strongest postcondition, denoted sp(π, true) or simply sp(π), which is the set of concrete program states (within abstract state sᵢ) that are reachable from any initial state via π. Note that sp is the standard (sequential) program transformer notion since π has a completely fixed thread schedule. Computing sp is not added overhead, since it comes for free during the generation of new data inputs (by flipping at b-PP nodes).

If sp(π)→eval(CS[sᵢ ]), then no new branch can be reached by extending the execution from s; therefore we can backtrack immediately;

Otherwise, there may be some branches reachable by extending the execution from s. In this case, we need to find the last pivot point sₖ (i<k≦n) along

$${s}_{i} {->}^{{e}_{i}} … {s}_{k} {->}^{{e}_{k}} … {s}_{n} {->}^{{e}_{n}} {s}_{n + 1}$$

such that sp(π;eᵢ . . . eₖ, true) [symbol] eval(CS[sₖ]), and flip at this pivot point. This coverage summary based pruning can be implemented in Algorithm 3 by calling a new procedure DetectFailure-CS (S,s) in line 19, consisting of:

1. the original DetectFailure (S,s);

2. computing CS[s].

Whenever a new state s′ is created, we try pruning the suffixes starting with s′ by calling a new procedure NextState-CS (s,t) in lines 7 and 14, consisting of:

1. s′ ← NextState(s,t);
2. if (sp(π) → eval(CS[s′])) { s′.explored ← s′.enabled ;

s′.branched ← s′.branch; }

3. return s′.

By properly setting s′.explored and s′.branched, we force subsequent call to Test (I,s′) to backtrack immediately, therefore pruning away the suffixes.

### EXAMPLE 2

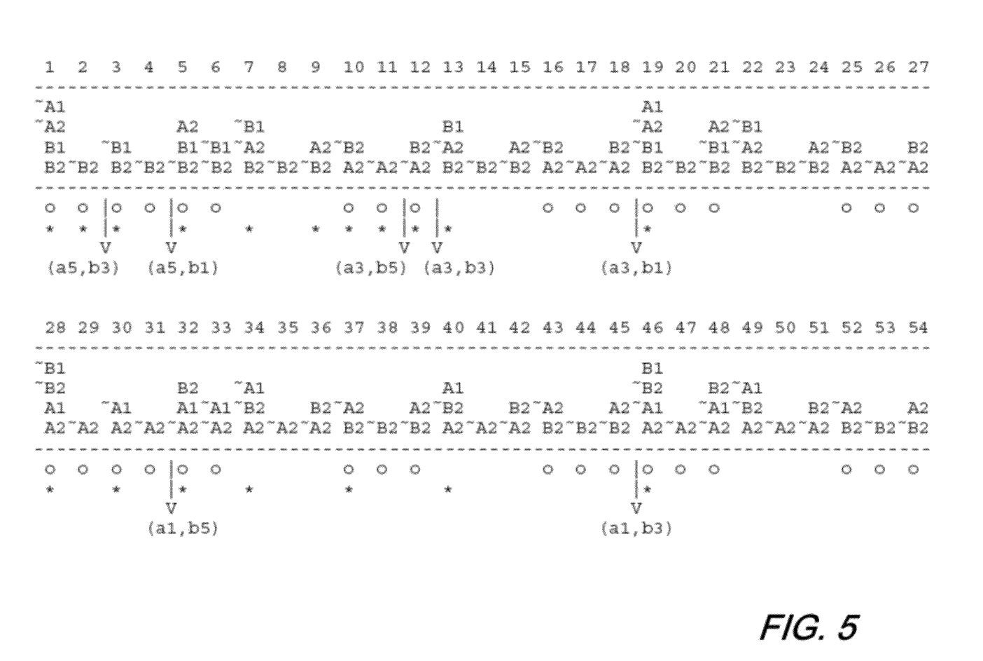

Consider program (2) in FIG. 1 whose 54 valid runs are list in FIG. 5. Although sharing the same GIG, this program has 54 significantly different runs from that of program (1) due to interference between the two threads. It is worth pointing out that a1:a=x++ and b1:b=x++ actually do not commute, because from state x=0, for instance, executing a1;b1 leads to a=0, b=1, x=2, but executing b1;a1 leads to a=1, b=0, x=2. Standard partial order reduction can reduce the 54 runs down to 34 runs, as marked by the symbol ‘∘’ in FIG. 4. Using coverage summary based pruning alone, we can reduce the 54 runs to the 18 runs marked by ‘*’, which is a better result than using POR alone. When using both, we can reduce the 54 runs to the 13 runs marked by both ‘∘’ and ‘*’. We omit the detailed description of the pruning process due to page limit. The steps where a eval(CS[s]) becomes true are marked at the bottom of FIG. 5.

Approximating the Coverage Summaries

The coverage summaries CS[n], for all n, as well as sp(π) may be expensive to compute, store, and lookup. Fortunately, we can use various practical strategies to reduce the computational cost, while still maintaining the soundness of the reduction (no missed bugs). In general we can use a combination of CSₛ⁻ which is any under-approximation of CS[s], and sp⁺(π) which is any over-approximation of sp(π). Whenever sp⁺(π)→CSₛ⁻ we can soundly skip all suffixes starting with s. This idea is illustrated by the right-hand-side figure, where π′ is a previous execution prefix from which CS[s] or CSₛ⁻ is computed, and π is the new execution prefix leading to s again. By definition, we have sp(π)→sp⁺(π) and CSₛ→CS[s]. Therefore if sp^{|}(π)→CSₛ, then sp(π)→CS[s] which formally establishes the correctness of pruning away all suffixes starting with s.

In practice we can use a map with fixed number of entries and lossy insertion to store CS[s]. Considering the potentially many distinct s, this implementation can limit the maximum memory usage. Upon hash key collision, i.e. key(s)=key(s′), we can heuristically remove either the entry s′, effectively making CS[s′]=false, or the entry s, effectively making CS[s]=false. Similarly, we can use a fixed threshold to bound the size of the individual formulas of CS[s] and sp(π).

```
  • if (sizeof( sp(π)) > threshold) sp⁺(π) = true ; else sp⁺(π) = sp(π);
  • if (sizeof( CS[s]) > threshold) CSₛ⁻ = false; else CSₛ⁻ = CS[s];
The baseline (no pruning) equals sp⁺(π) = true for all π, and
```

CSₛ⁻ = false for all s.

The benefit of our framework is that one can systematically explore various practical ways of trading off the pruning power for reduced computational overhead, not worrying about soundness of the individual choices. This is in contrast to ad hoc reductions, where one has to be careful not to drop executions that lead to bugs.

Experiments

We have implemented the proposed techniques in a dynamic testing tool designed for multithreaded C programs using POSIX threads. We use some public domain Linux applications as benchmarks to demonstrate the feasibility of our framework. Our implementation uses the C/C++ front-end from Edison Design Group to automatically insert monitoring and control code in the original program, allowing a CHESS-like tool to supervise a concurrent execution with a given (I, sch). The modified program is instrumented again using CIL to add self-logging capability: program statements are logged as symbolic events every time they are executed. Static analysis such as slicing and constant folding are used to simplify the logged trace (often with several orders of magnitude reduction in size), before we start symbolic reasoning with an SMT solver.

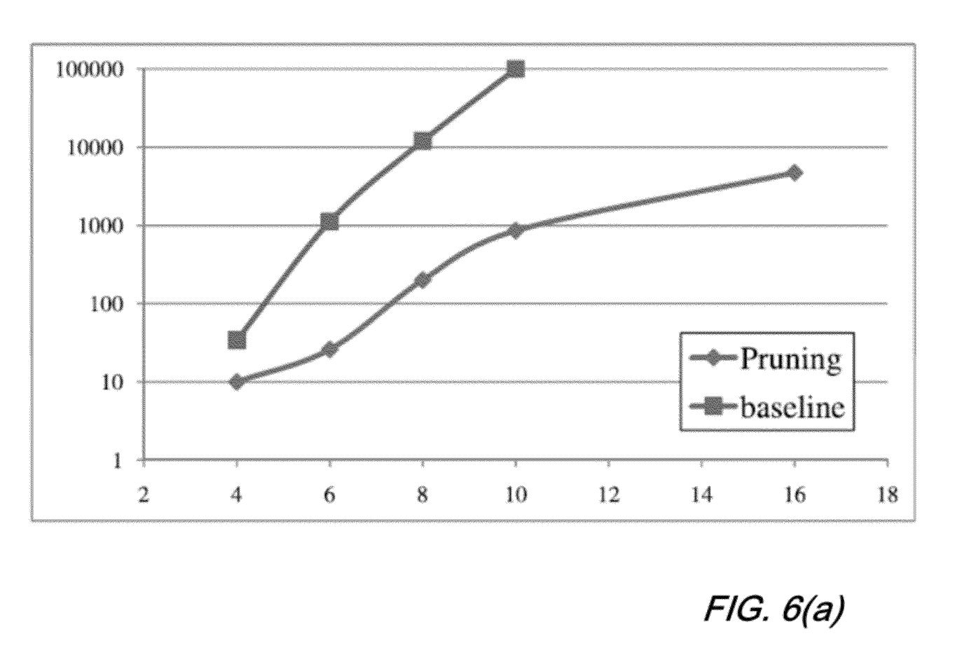

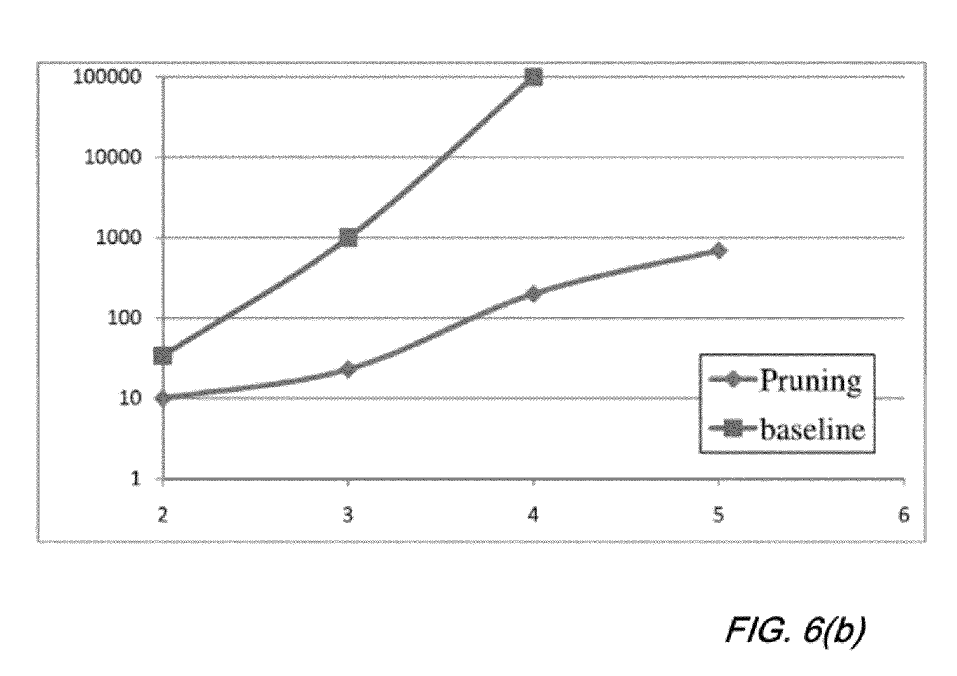

In our preliminary experiments, we have observed the exponential speedup provided by coverage summary based pruning, confirming its effectiveness. The first set of experiments were on qsort_mt, a multithreaded implementation of quick sort with around 700 lines of C code. We parameterized the program by choosing various numbers of worker threads and various sizes of the input data array. We marked all input array elements as symbolic inputs. The results are in FIG. 6(a) and FIG. 6(b). With larger input array sizes (FIG. 6(a) and more worker threads (FIG. 6(b) we saw the number of tests and the run time increased quickly, but significantly more so without pruning than with pruning

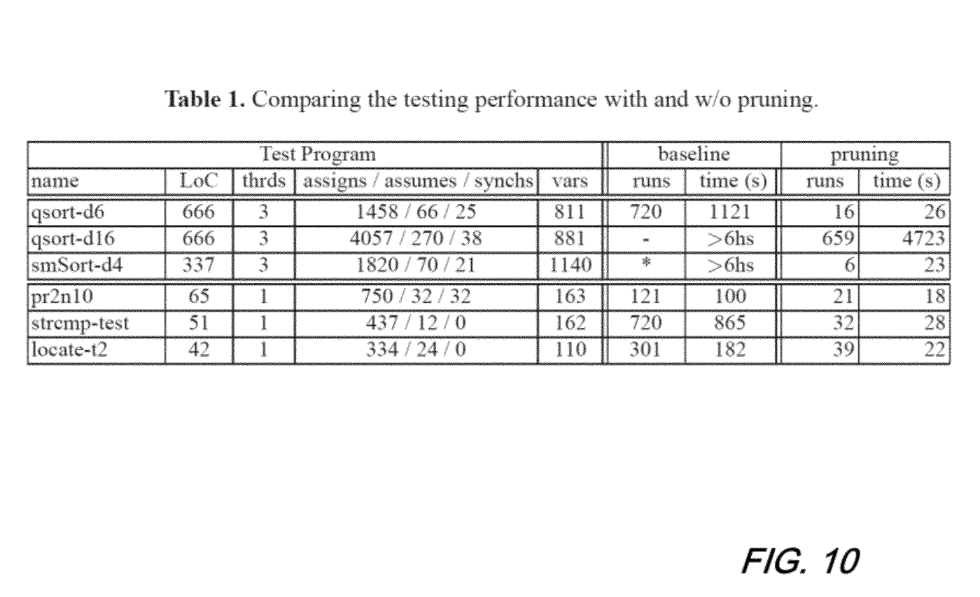

The results for another set of experiments are shown in Table 1 (FIG. 10). Here smSort is a multithreaded implementation of merge sort, pr2n10 is a parameterized version of our running example, with each thread in a loop of 5 iterations, strcmp-test comes from, where it is used to showcase a demand-driven abstraction-refinement style hybrid concolic testing algorithm, and locate-t2 is a variant of the example from, where it is used to illustrate a function summary based compositional test generation algorithm. On all these examples, our pruning method performed reasonably well. The last three examples (with 1 thread) are used for comparison against other sequential methods. Specifically, on the last two examples, our method achieved comparable performance to existing methods—we consider this an advantage since iterative refinements or function summaries are not easy to apply to concurrent programs.

The results in FIG. 6(a) and FIG. 6(b) and Table 1 demonstrate the promising results from our method, but some implementation issues need to be resolved before it can routinely handle large Linux applications. One problem is modeling system/library calls, which can be difficult without their source code. Another problem is modeling non-linear arithmetic, which has not been fully supported by SMT solvers. We have under-approximated such operations by using concrete values observed during the actual execution, but this is known to cause execution to deviate from what needs to be covered by the test. In Table 1, the non-terminating result of baseline for smSort is due to such deviation. We are currently working on precise modeling of library calls with uclibc, which has source code of some commonly used C libraries. An alternative would be directly testing multithreaded x86 executables.

Our testing method can also be improved by using static analysis together with the coverage summary based pruning to remove more redundant tests. (The optimal solution for FIG. 3 requires runs 1 and 19 only.) However, we consider it as a strength that sophisticated static analysis is not mandatory in our dynamic testing framework; this makes it more widely applicable in practice.

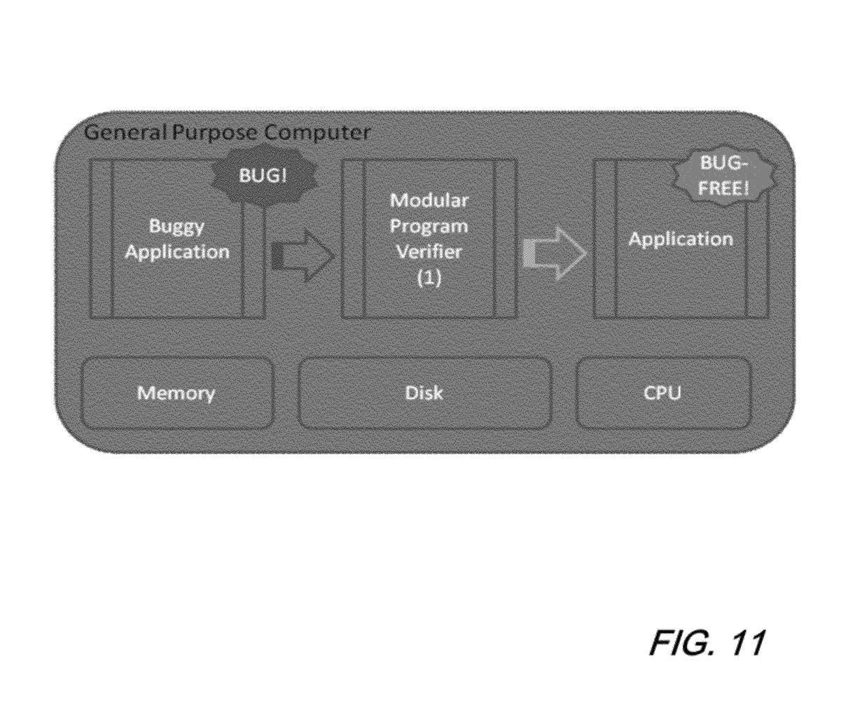

Turning now to FIG. 11, there is shown a simplified, schematic block diagram depicting a general purpose computer executing the method according to the present disclosure. As generally depicted therein, a buggy application program, may be applied to our modular program verifier and a bug-free application may result.

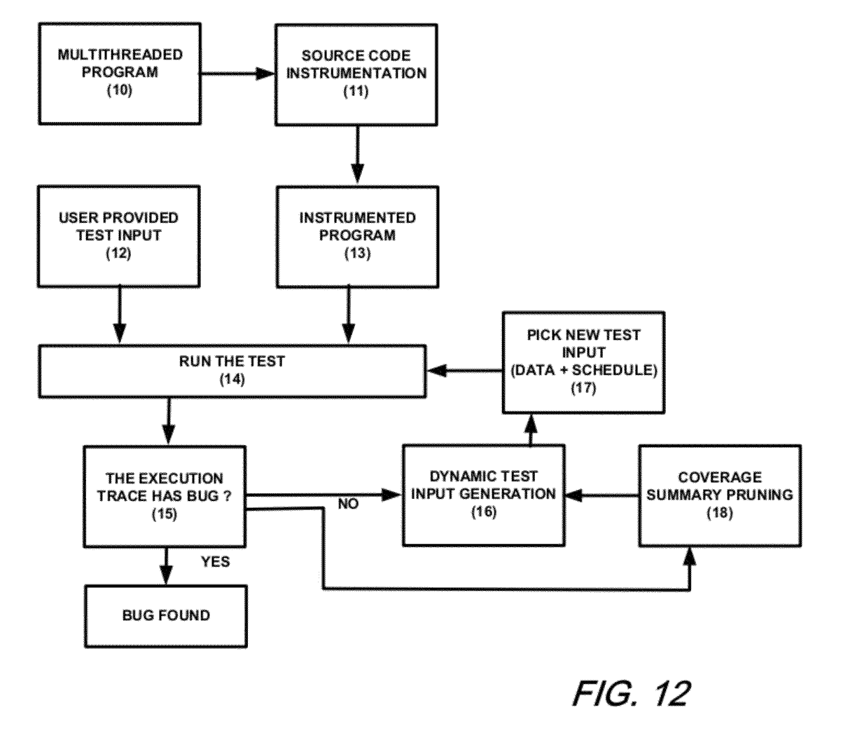

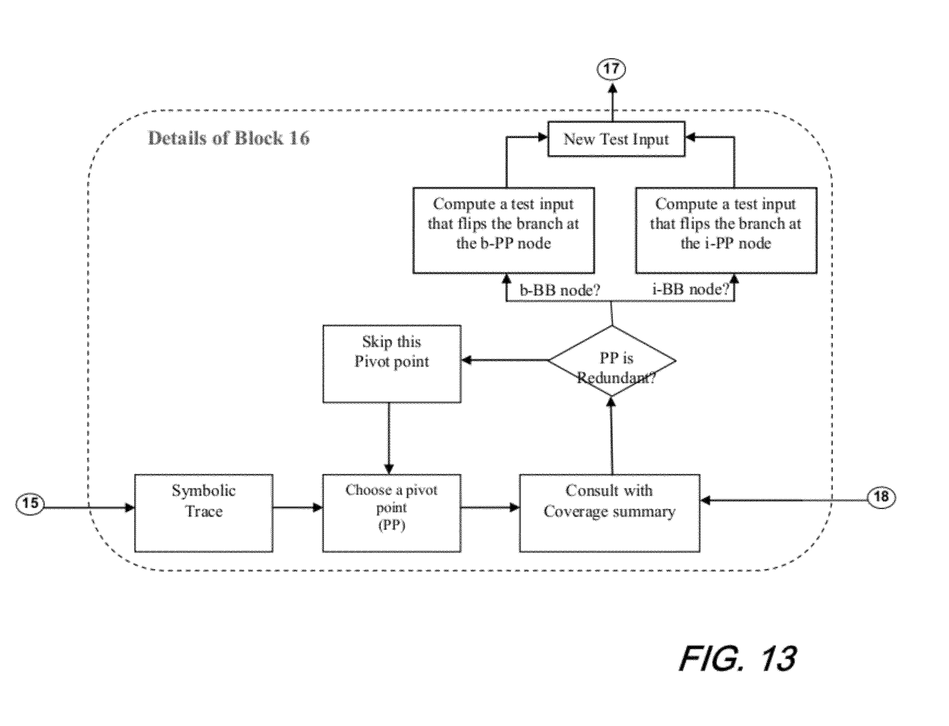

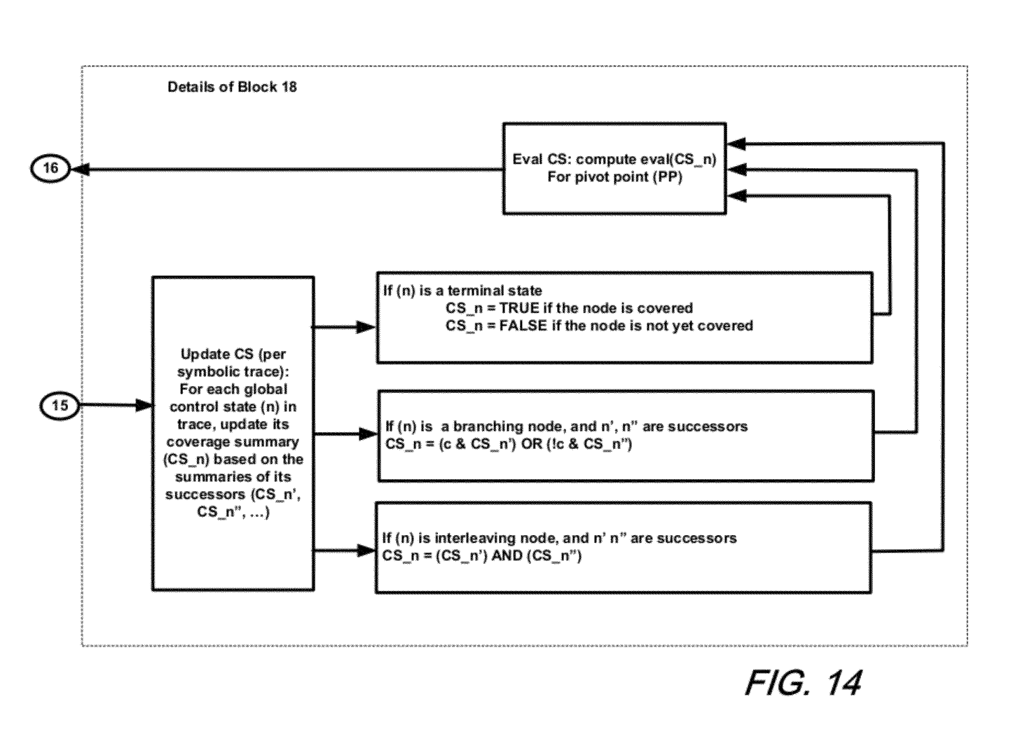

More particularly, and with simultaneous reference to the flow diagram depicted in FIG. 12, FIG. 13, and FIG. 14, a multithreaded computer software program (10) and applying source code instrumentation (11), a fully instrumented program is produced (13). That fully instrumented program (13), along with user provided test input (12) is tested (14) once to produce an execution trace. If that execution trace is erroneous (15), a bug has been found.

If that execution trace is not erroneous (15), then dynamic test generation (16) is applied to generate the next test input to execute (17). The new test is run (14), and if that execution trace is erroneous (15), a bug has been found. The steps of blocks (14)-(18) are repeated until a bug is found in the trace.

FIG. 13 shows the details of block 16 (16), which determines the next dynamic test input generation. As may be observed from that FIG. 13, a pivot point (PP) is chosen from a symbolic trace and if that PP is redundant, it is skipped. If not, then a new test input that flips the interleaving Pivot Point (i-PP) or branching Pivot Point (b-PP)—as appropriate—is generated. This new test input is used for re-running the test (block 14).

As noted in FIG. 13, coverage summary is determined at block 18 (18) which—updates coverage summary for each global control state based on the summaries of its successors.

Those skilled in the art will recognize that our description provided herein is merely exemplary and additional variations to our teachings are possible and contemplated. Accordingly, the scope of the disclosure should only be limited by the claims appended hereto.

1. A computer implemented method for identifying faults in a concurrent software program comprising:
a) generating new test inputs and thread schedules to systematically cover sequential paths and interleavings with respect to a given coverage metric;
b) computing coverage summaries for global control points, and using them to prune away redundant sequential paths and redundant concurrent interleavings;
c) testing the program using the generated test inputs and thread schedules to determine whether the tested program includes faults and outputting an indicia of the found faults.

2. The computer implemented method of claim 1 wherein the new test inputs are dynamically generated by using symbolic execution, to force the program to execute a different trace.

3. The computer implemented method of claim 2 wherein the new test input may force the program to execute the same trace prefix but switches at a branching pivot point to a different if-else branch, hence leading to a different sequential path.

4. The computer implemented method of claim 2 wherein the new test input may force the program to execute the same trace prefix, but switches at an interleaving pivot point to schedule a different thread, hence leading to a different interleaving.

5. The computer implemented method of claim 2 wherein the new test input generation is performed systematically by recording the set of covered execution traces, so that no trace is repeated and all traces are effectively covered.

6. The computer implemented method of claim 1 wherein a coverage summary is computed for each global control state, by symbolically executing along a concrete trace, and computing the coverage summaries of its successor states recursively.

7. The computer implemented method of claim 6 wherein the coverage summary at a branching pivot point is computed by disjunctively merging the coverage summaries of the two successor states corresponding to the if-branch and the else-branch, respectively.

8. The computer implemented method of claim 6 wherein the coverage summary at an interleaving pivot point is computed by conjunctively merging the coverage summaries of the successor states corresponding to different thread schedules.

9. The computed implemented method of claim 1 wherein a prefix of a path is checked and the remaining path is pruned if the post-condition of the prefix is included in the coverage summary of the global control point at the end of the prefix.

10. The computed implemented method of claim 9 wherein an under-approximation of the coverage summary is used to check for pruning

11. The computer implemented method of claim 9 wherein an over-approximation of the post-condition of the prefix is used to check for pruning

12. The computer implemented method of claim 2 wherein new test inputs are generated by symbolic execution using an SMT (Satisfiability Modulo Theory) solver.

13. A computer implemented system for identifying faults in a concurrent software program, said system begin operable to:
a) generate new test inputs and thread schedules to systematically cover sequential paths and interleavings with respect to a given coverage metric;
b) compute coverage summaries for global control points, and using them to prune away redundant sequential paths and redundant concurrent interleavings;
c) test the program using the generated test inputs and thread schedules to determine whether the tested program includes faults and outputting an indicia of the found faults.

14. The computer implemented system of claim 13 wherein the new test inputs are dynamically generated by using symbolic execution, to force the program to execute a different trace.

15. The computer implemented system of claim 14 wherein the new test input may force the program to execute the same trace prefix but switches at a branching pivot point to a different if-else branch, hence leading to a different sequential path.

16. The computer implemented system of claim 14 wherein the new test input may force the program to execute the same trace prefix, but switches at an interleaving pivot point to schedule a different thread, hence leading to a different interleaving.

17. The computer implemented system of claim 14 wherein the new test input generation is performed systematically by recording the set of covered execution traces, so that no trace is repeated and all traces are effectively covered.

18. The computer implemented system of claim 13 wherein a coverage summary is computed for each global control state, by symbolically executing along a concrete trace, and computing the coverage summaries of its successor states recursively.

19. The computer implemented system of claim 18 wherein the coverage summary at a branching pivot point is computed by disjunctively merging the coverage summaries of the two successor states corresponding to the if-branch and the else-branch, respectively.

20. The computer implemented system of claim 18 wherein the coverage summary at an interleaving pivot point is computed by conjunctively merging the coverage summaries of the successor states corresponding to different thread schedules.
